(19) United States
(12) Patent Application Publication
(10) Pub. No.: US 2024/0385036 A1
(43) Pub. Date: Nov. 21, 2024

(54) MICROSCOPIC RAMAN DEVICE

(71) Applicant: SHIMADZU CORPORATION, Kyoto (JP)

(72) Inventors: Ryuta SHIBUTANI, Kyoto (JP); Tomoyo TAO, Kyoto (JP)

(73) Assignee: SHIMADZU CORPORATION, Kyoto (JP)

(21) Appl. No.: 18/686,416

(22) PCT Filed: Mar. 16, 2022
(86) PCT No.: PCT/JP2022/011938

§ 371 Date: May 30, 2024

(30) Foreign Application Priority Data
Aug. 31, 2021 (JP) 2021-141048

(51) Int. Cl. G01J 3/02; G01J 3/10; G01J 3/44; G01N 21/65

(52) U.S. Cl. CPC G01J 3/0232; G01J 3/0237; G01J 3/0275; G01J 3/10; G01J 3/44; G01N 21/65; G01J 2003/102; G01N 2201/063

(57) ABSTRACT

A microscopic Raman device includes: a sample set unit that has a cover which is openable and closable, and that stores a sample therein; a first laser light source that generates first laser light to be projected onto the sample; a shutter disposed on a first light path which is a light path of the first laser light from the first laser light source to the sample; a shutter drive unit that opens and closes the shutter; and a sensor. The shutter drive unit is configured to close the shutter when the sensor senses that the cover starts to be opened. The shutter blocks the first laser light when closed.

### TECHNICAL FIELD

The present disclosure relates to a microscopic Raman device.

### BACKGROUND ART

For example, Japanese Patent Laying-Open No. 10-90064 (PTL 1) describes a microscopic Raman device. The microscopic Raman device described in PTL 1 has a pumping laser, a spectroscope, and a detector. In the microscopic Raman device described in PTL 1, laser light from the pumping laser is projected onto a sample, and thereby Raman scattered light is generated from the sample. The Raman scattered light is dispersed in the spectroscope, and the intensity distribution of the dispersed Raman scattered light is detected in the detector.

### CITATION LIST

### Patent Literature

PTL 1: Japanese Patent Laying-Open No. 10-90064

### SUMMARY OF INVENTION

### Technical Problem

In the microscopic Raman device described in PTL 1, the sample is stored, for example, in a sample set unit that has a cover which is openable and closable. Depending on the class of laser light, exposure to laser light is prohibited. Accordingly, when the cover is opened to perform an operation on the inside of the sample set unit, it is necessary to turn off the pumping laser. However, once the pumping laser is turned off, it takes time until the output of the pumping laser is stabilized after it is turned on again.

The present disclosure has been made in view of the problem of the conventional technique as described above. More specifically, the present disclosure provides a microscopic Raman device in which an operation on the inside of a sample set unit can be performed without turning off a laser light source.

### Solution to Problem

A microscopic Raman device of the present disclosure includes: a sample set unit that has a cover which is openable and closable, and that stores a sample therein; a first laser light source that generates first laser light to be projected onto the sample; a shutter disposed on a first light path which is a light path of the first laser light from the first laser light source to the sample; a shutter drive unit that opens and closes the shutter; and a sensor. The shutter drive unit is configured to close the shutter when the sensor senses that the cover starts to be opened. The shutter blocks the first laser light when closed.

In the microscopic Raman device, the shutter drive unit may be a solenoid. The microscopic Raman device may further include a second laser light source that generates second laser light to be projected onto the sample. The shutter may be disposed on a portion of the first light path that overlaps a second light path which is a light path of the second laser light from the second laser light source to the sample. The shutter blocks the first laser light and the second laser light when closed.

The microscopic Raman device may further include: a beam splitter disposed on the first light path; an illumination light source that generates illumination light to be projected onto the sample; and a camera. The beam splitter may cause the first laser light to pass therethrough, and reflect the illumination light reflected in the sample and cause the reflected illumination light to enter the camera. The shutter may be disposed on a portion of the first light path that is closer to the first laser light source than the beam splitter.

### Advantageous Effects of Invention

According to the microscopic Raman device of the present disclosure, an operation on the inside of a sample set unit can be performed without turning off a laser light source.

### BRIEF DESCRIPTION OF DRAWINGS

FIG. 1 is a schematic configuration diagram of a microscopic Raman device 100.

FIG. 2 is a schematic configuration diagram of a microscopic Raman device 200.

FIG. 3 is a schematic configuration diagram of a microscopic Raman device 300.

### DESCRIPTION OF EMBODIMENTS

Details of embodiments of the present disclosure will be described with reference to the drawings. In the drawings below, identical or corresponding parts will be designated by the same reference numerals, and overlapping description will not be repeated.

### First Embodiment

In the following, a microscopic Raman device according to a first embodiment (hereinafter referred to as a “microscopic Raman device 100”) will be described.

### <Configuration of Microscopic Raman Device 100>

In the following, a configuration of microscopic Raman device 100 will be described.

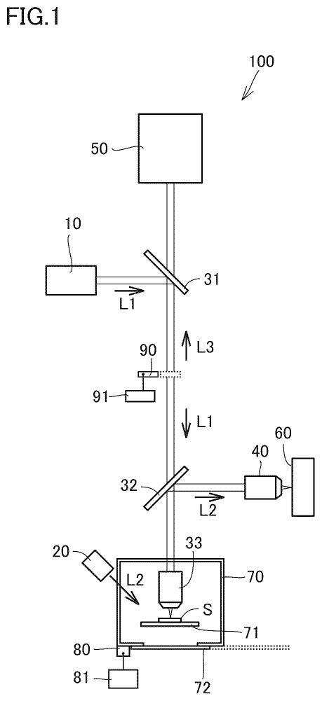

FIG. 1 is a schematic configuration diagram of microscopic Raman device 100. As shown in FIG. 1, microscopic Raman device 100 has a first laser light source 10 and an illumination light source 20. Microscopic Raman device 100 has a beam splitter 31, a beam splitter 32, an objective lens 33, and a camera lens 40.

Microscopic Raman device 100 further has a Raman spectroscope 50, a camera 60, a sample set unit 70, a sensor 80, a controller 81, a shutter 90, and a shutter drive unit 91. A sample S is stored in sample set unit 70.

First laser light source 10 generates first laser light L1. The wavelength of first laser light L1 is a first wavelength. Illumination light source 20 generates illumination light L2. Illumination light L2 is visible light. The wavelength of illumination light L2 is a second wavelength. The second wavelength is different from the first wavelength.

Beam splitter 31 reflects light having a wavelength that is less than or equal to the first wavelength, and causes light having a wavelength that is more than the first wavelength to pass therethrough. Beam splitter 32 reflects light having a wavelength close to the second wavelength, and causes light having a wavelength other than that to pass therethrough.

First laser light L1 generated in first laser light source 10 is reflected by beam splitter 31. First laser light L1 reflected by beam splitter 31 passes through beam splitter 32, and is collected by objective lens 33 and projected onto sample S. Hereinafter, a light path of first laser light L1 from first laser light source 10 to sample S is referred to as a first light path.

By projecting first laser light L1 onto sample S, first Raman scattered light L3 is generated from sample S. The wavelength of first Raman scattered light L3 shifts from the first wavelength to a longer wavelength. First Raman scattered light L3 sequentially passes through objective lens 33, beam splitter 32, and beam splitter 31.

First Raman scattered light L3 that has passed through beam splitter 31 enters Raman spectroscope 50. Although not shown, Raman spectroscope 50 has a collimator lens, a grating, a camera lens, and a detector. It should be noted that the detector is a CCD (Charge Coupled Device) camera, for example.

First Raman scattered light L3 that has entered Raman spectroscope 50 is converted into parallel light by the collimator lens. First Raman scattered light L3 that has passed through the collimator lens is dispersed by the grating, and is collected to the detector by the camera lens. Thereby, the spectrum of first Raman scattered light L3 is measured in the detector.

Although not shown, microscopic Raman device 100 may further have a second laser light source. The second laser light source generates second laser light. The wavelength of the second laser light is a third wavelength. The third wavelength is different from the first wavelength and the second wavelength. The second laser light passes through a second light path and is projected onto sample S. The second light path may partially overlap the first light path. For example, the second light path overlaps the first light path at a portion from beam splitter 31 to sample S.

By projecting the second laser light onto sample S, second Raman scattered light is generated from sample S. The wavelength of the second Raman scattered light shifts from the third wavelength to a longer wavelength. The second Raman scattered light passes through an appropriate optical system and is collected to the detector of Raman spectroscope 50, and thereby the spectrum of the second Raman scattered light is measured.

Illumination light L2 generated in illumination light source 20 is projected onto sample S and reflected by sample S. Illumination light L2 reflected by sample S passes through objective lens 33 and is reflected by beam splitter 32. Illumination light L2 reflected by beam splitter 32 is collected by camera lens 40 and projected onto camera 60. Camera 60 is a CMOS (Complementary Metal Oxide Semiconductor) camera, for example. By connecting camera 60 to a monitor (not shown), the inside of sample set unit 70 is observed.

Sample set unit 70 has a stage 71 and a cover 72. Stage 71 is in the inside of sample set unit 70. Sample S is disposed on stage 71. Cover 72 is openable and closable. By opening cover 72, an operation in the inside of sample set unit 70 (for example, an operation on sample S) can be performed.

Sensor 80 is attached to sample set unit 70, for example. Sensor 80 senses that cover 72 starts to be opened, and outputs a signal indicating that cover 72 starts to be opened. For example, sensor 80 is a magnetic sensor, and senses a change in magnetic field from a magnet attached to cover 72, and thereby outputs a signal according to the change in magnetic field. Sensor 80 is connected to controller 81. Controller 81 is constituted by a microcontroller, for example.

Shutter 90 is disposed on the first light path. Preferably, shutter 90 is disposed on a portion of the first light path that overlaps the second light path. More preferably, shutter 90 is disposed on a portion of the first light path that is located between beam splitter 31 and beam splitter 32. From another viewpoint, it is preferable that shutter 90 is disposed closer to first laser light source 10 (the second laser light source) than beam splitter 32 on the first light path (on the second light path).

Shutter 90 is opened and closed by shutter drive unit 91. Shutter 90 blocks first laser light L1 when closed. In a case where microscopic Raman device 100 further has the second laser light source, shutter 90 further blocks the second laser light. Shutter drive unit 91 is a solenoid, for example. Shutter drive unit 91 may be a motor. Although not shown, shutter drive unit 91 is connected to controller 81.

As described above, when sensor 80 senses that cover 72 starts to be opened, sensor 80 outputs a signal indicating that cover 72 starts to be opened. When controller 81 receives from sensor 80 the signal indicating that cover 72 starts to be opened, controller 81 controls shutter drive unit 91 to close shutter 90. For example, in a case where shutter drive unit 91 is a solenoid, when controller 81 receives from sensor 80 the signal indicating that cover 72 starts to be opened, controller 81 switches the polarity of energization to shutter drive unit 91 and thereby closes shutter 90. On the other hand, when sensor 80 outputs a signal indicating that cover 72 is closed, controller 81 controls shutter drive unit 91 to open shutter 90.

### <Effect of Microscopic Raman Device 100>

In the following, the effect of microscopic Raman device 100 will be described in comparison with a microscopic Raman device according to a comparative example (hereinafter referred to as a “microscopic Raman device 200”).

Depending on the class of laser light, exposure to laser light is prohibited. Accordingly, a device using a laser needs to have a mechanism that prevents exposure to laser light.

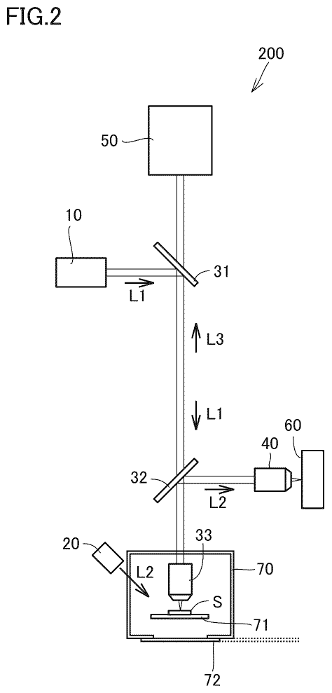

FIG. 2 is a schematic configuration diagram of microscopic Raman device 200. As shown in FIG. 2, the configuration of microscopic Raman device 200 is common to the configuration of microscopic Raman device 100, except that microscopic Raman device 200 does not have sensor 80, controller 81, shutter 90, and shutter drive unit 91.

In microscopic Raman device 200, when cover 72 is opened in an attempt to perform an operation on the inside of sample set unit 70, it is necessary to turn off first laser light source 10 in order to prevent exposure to first laser light L1. When cover 72 is closed, first laser light source 10 is turned on again.

However, it takes time until the output of first laser light source 10 is stabilized, and thus a waiting time is produced from when cover 72 is opened to perform the operation on the inside of sample set unit 70 to when cover 72 is closed again to conduct an analysis using microscopic Raman device 200. Since the operation on the inside of sample set unit 70 by opening cover 72 is usually performed repeatedly, microscopic Raman device 200 has a low analysis efficiency due to the waiting time described above.

In contrast, in microscopic Raman device 100, when cover 72 is opened in an attempt to perform an operation on the inside of sample set unit 70, sensor 80 senses that cover 72 starts to be opened, and shutter 90 is closed by shutter drive unit 91. As a result, first laser light L1 is blocked by shutter 90, and thus exposure to first laser light L1 when cover 72 is opened is prevented even if first laser light source 10 is not turned off.

As a result, no waiting time is produced from when cover 72 is opened to perform the operation on the inside of sample set unit 70 to when cover 72 is closed again to conduct an analysis using microscopic Raman device 100. Thus, according to microscopic Raman device 100, the waiting time associated with switching of first laser light source 10 between an ON state and an OFF state can be eliminated, and thereby analysis efficiency is improved.

In the case where shutter drive unit 91 is a solenoid, when sensor 80 senses that cover 72 starts to be opened, shutter 90 is closed quickly. Accordingly, in this case, exposure to first laser light L1 when cover 72 is opened is prevented more reliably.

In a case where shutter 90 is disposed on a portion of the first light path that overlaps the second light path, one shutter 90 can block both first laser light L1 and the second laser light, and thus the number of parts of microscopic Raman device 100 can be decreased and the manufacturing cost of microscopic Raman device 100 can be reduced.

In a case where shutter 90 is disposed closer to sample S than beam splitter 32 on the first light path, for example, illumination light L2 reflected by sample S is blocked by shutter 90. Accordingly, in this case, it is not possible to observe the inside of sample set unit 70 when cover 72 is opened to perform an operation on the inside of sample set unit 70.

In contrast, in a case where shutter 90 is disposed closer to first laser light source 10 (i.e., disposed further away from sample S) than beam splitter 32 on the first light path, illumination light L2 reflected by sample S is not blocked by shutter 90 even when cover 72 is opened to perform an operation on the inside of sample set unit 70. Accordingly, in this case, it is possible to observe the inside of sample set unit 70 while cover 72 is opened to perform the operation on the inside of sample set unit 70.

### Second Embodiment

In the following, a microscopic Raman device according to a second embodiment (hereinafter referred to as a “microscopic Raman device 300”) will be described. Here, differences from microscopic Raman device 100 will be mainly described, and overlapping description will not be repeated.

### <Configuration of Microscopic Raman Device 300>

In the following, a configuration of microscopic Raman device 300 will be described.

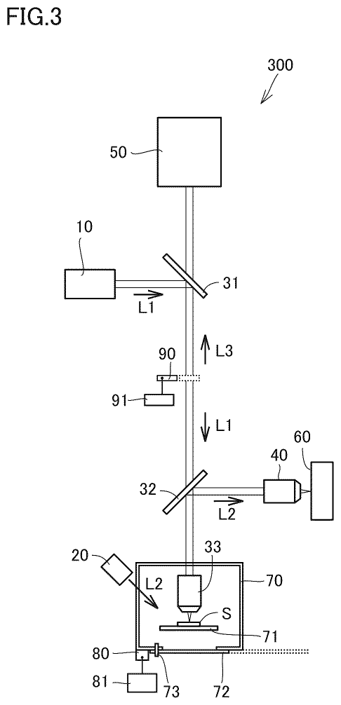

FIG. 3 is a schematic configuration diagram of microscopic Raman device 300. As shown in FIG. 3, microscopic Raman device 300 has first laser light source 10 and illumination light source 20. Microscopic Raman device 300 has beam splitter 31, beam splitter 32, objective lens 33, and camera lens 40.

Microscopic Raman device 300 further has Raman spectroscope 50, camera 60, sample set unit 70, sensor 80, controller 81, shutter 90, and shutter drive unit 91. Raman spectroscope 50 has the collimator lens, the grating, the camera lens, and the detector. Sample set unit 70 has stage 71 and cover 72. In these regards, the configuration of microscopic Raman device 300 is common to the configuration of microscopic Raman device 100.

In microscopic Raman device 300, sample set unit 70 further has a cover lock mechanism 73. Cover lock mechanism 73 can be switched between a first state in which cover 72 can be opened and closed, and a second state in which cover 72 cannot be opened and closed. In microscopic Raman device 300, sensor 80 senses that the state of cover lock mechanism 73 is switched from the second state to the first state, and outputs a signal indicating that the state of cover lock mechanism 73 is switched from the second state to the first state.

In microscopic Raman device 300, upon receiving from sensor 80 the signal indicating that the state of cover lock mechanism 73 is switched from the second state to the first state, controller 81 controls shutter drive unit 91 to close shutter 90. In these regards, the configuration of microscopic Raman device 300 is different from the configuration of microscopic Raman device 100.

### <Effect of Microscopic Raman Device 300>

In microscopic Raman device 300, as described above, shutter 90 is closed upon switching of cover lock mechanism 73 from the second state to the first state. Accordingly, as in microscopic Raman device 100, exposure to first laser light LI when cover 72 is opened is prevented even if first laser light source 10 is not turned off.

Although the embodiments of the present disclosure have been described above, it is also possible to modify the embodiments described above in various manners. Further, the scope of the present invention is not limited to the embodiments described above. The scope of the present invention is defined by the scope of the claims, and is intended to include any modifications within the scope and meaning equivalent to the scope of the claims.

### REFERENCE SIGNS LIST

100, 200, 300: microscopic Raman device; 10: first laser light source; 20: illumination light source; 31: beam splitter; 32: beam splitter; 33: objective lens; 40: camera lens; 50: Raman spectroscope; 60: camera; 70: sample set unit; 71: stage; 72: cover; 73: cover lock mechanism; 80: sensor; 81: controller; 90: shutter; 91: shutter drive unit; L1: first laser light; L2: illumination light; L3: first Raman scattered light; S: sample.

1. A microscopic Raman device comprising:
a sample set unit that has a cover which is openable and closable, and that stores a sample therein;
a first laser light source that generates first laser light to be projected onto the sample;
a shutter disposed on a first light path which is a light path of the first laser light from the first laser light source to the sample;
a shutter drive unit that opens and closes the shutter; and
a sensor, wherein
the shutter drive unit is configured to close the shutter by the sensor sensing that the cover is opened, and
the shutter blocks the first laser light by the sensor sensing that the cover is closed,
the microscopic Raman device further comprising:
a beam splitter disposed on the first light path;
an illumination light source that generates illumination light to be projected onto the sample; and
a camera, wherein
the beam splitter causes the first laser light to pass therethrough, and reflects the illumination light reflected in the sample and causes the reflected illumination light to enter the camera, and
the shutter is disposed on a portion of the first light path between that is closer to the first laser light source than the beam splitter.

2. The microscopic Raman device according to claim 1, wherein the shutter drive unit is a solenoid.

3. The microscopic Raman device according to claim 1, further comprising a second laser light source that generates second laser light to be projected onto the sample, wherein
the shutter is disposed on a portion of the first light path that overlaps a second light path which is a light path of the second laser light from the second laser light source to the sample, and
the shutter blocks the first laser light and the second laser light when closed.

4. (canceled)
